(19) United States
(12) Patent Application Publication
(10) Pub. No.: US 2006/0025113 A1
(43) Pub. Date: Feb. 2, 2006

(54) Methods, systems, and storage mediums for providing message delivery and notification services

(76) Inventors: Hong Nguyen, Atlanta, GA (US); Michael L. Bishop, Atlanta, GA (US)

Correspondence Address: CANTOR COLBURN LLP, 55 GRIFFIN ROAD SOUTH, BLOOMFIELD, CT, 06002, US

(21) Appl. No.: 10/900,596

(22) Filed: Jul. 28, 2004

(51) Int. Cl. H04M 11/00

(52) U.S. Cl. 455/412.1; 455/412.2; 455/414.2

(57) ABSTRACT

Exemplary embodiments include methods, systems, and storage mediums for providing message delivery and notification services. The method includes collecting data associated with a message, collecting notification information relating to an originator of the message, and generating a notification in response to the notification information. The generating is performed when the message is accessed by a recipient. The method also includes transmitting the notification to the originator of the message.

### BACKGROUND OF INVENTION

Embodiments of the invention relate generally to telecommunications services, and more particularly, to methods, systems, and storage mediums for providing message delivery and notification services.

A variety of value-added services are being introduced in the telecommunications industry in order to attract new customers and remain competitive in a market that is continuously evolving in light of advancements in technology and customer demands. As society becomes more mobile and business environments become faster paced, many individuals are looking for new ways to become more productive with increasingly more limited amounts of time. One area in which valuable time may be wasted is when an individual is attempting to contact another but without success. Oftentimes the individual will place multiple telephone calls, leaving voicemails, and/or emails, etc. until he/she makes contact with the target party. Without receiving a response to a voicemail, for example, an individual may have no way of knowing if his/her message made it to the proper voice mailbox, and if it did, whether the target party accessed it. The calling party is left with few options other than to continue to call and establish this contact.

What is needed is a more efficient way to communicate with individuals that provides the calling party with useful information about the outcome of their calls.

### SUMMARY OF INVENTION

The above disadvantages and shortcomings are overcome or alleviated by methods, systems, and storage mediums for providing message delivery and notification services. Methods include collecting data associated with a message, collecting notification information relating to an originator of the message, and generating a notification in response to the notification information. The generating is performed when the message is accessed by a recipient. The method also includes transmitting the notification to the originator of the message.

Systems for providing message delivery and notification services include a host system in communication with a calling device over a network. The host system executes a message delivery and notification application for collecting data associated with a message conveyed by the calling device, collecting notification information relating to an originator of the message, and generating a notification in response to the notification information. The generating is performed when the message is accessed by a recipient. The message delivery and notification application also transmits the notification to the originator of the message.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF DRAWINGS

Referring now to the drawings wherein like elements are numbered alike in the several FIGURES:

FIG. 1 is a block diagram of a system upon which the message delivery and notification services may be implemented in exemplary embodiments;

FIG. 2 is a flowchart describing a process for implementing the message delivery and notification services in exemplary embodiments;

FIG. 3 is a flowchart describing a process for implementing the no-ring feature of the message delivery and notification services in exemplary embodiments; and

FIG. 4 illustrates a sample user interface screen displaying a sample profile record that was created using the message delivery and notification application in exemplary embodiments.

### DETAILED DESCRIPTION

In accordance with exemplary embodiments, methods, systems, and storage mediums for providing message delivery and notification services are presented. The message delivery and notification services enable a calling individual to leave messages with a target party (also referred to herein as ‘recipient’) and receive instant notification when the target party accesses the message. The message and delivery notification services further enable a calling party to bypass a portion of the initiated call by leaving a message without first establishing direct contact with a party. The message delivery and notification services accommodate multiple types and formats of notifications to include telephone messages, voicemail messages, email, and facsimile, to name a few.

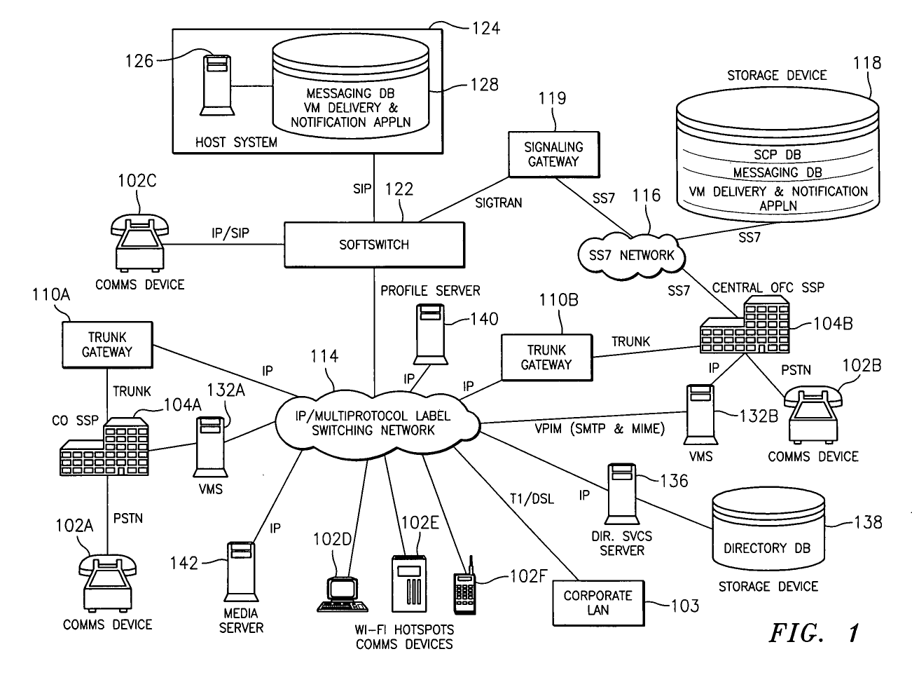

Turning now to FIG. 1, an exemplary system upon which the message delivery and notification services may be implemented will now be described. While the invention is described herein with respect to voicemail messages, it will be understood by those skilled in the art that other types of messages may be utilized in order to realize the advantages of the invention. In exemplary embodiments, the system of FIG. 1 includes communications devices 102A-102F. Communications devices 102A-B represent wireline telephones that communicate over a circuit-switched (e.g., standard public switched telephone network (PSTN) 106). Communications devices 102A-B may also receive voicemail messages and voicemail notification messages over the circuit-switched network as described further herein.

In accordance with exemplary embodiments, communications device 102C represents a standard wireline telephone utilizing Internet telephony technology, such as an Internet telephony service provider service along with a unique code that is entered into the device 102C prior to entering the telephone number to be called. With the advent of gateway servers and Voice over the Internet (VoIP) protocols, communications device 102C may initiate a telephone call that is processed and transmitted over a combination of networks, e.g., circuit-switched and packet-switched networks.

In exemplary embodiments, communications device 102D represents a wireless or wireline computer device such as a personal computer or laptop. With the proper tools (e.g., an Internet service subscription and modem, voice communications software, a microphone, sound card, and receiver), communications device 102D may implement voice communications over a packet-switched network. The computer may be a personal computer (e.g., desktop, laptop) that communicates over a network using an Internet service provider (ISP). Communications device 102D may also communicate over the Internet utilizing, e.g., digital subscriber line (DSL), cable, dial-up, wireless communications protocols (Bluetooth, WAP, etc.), and/or other known networking technologies. Communications device 102D may also include messaging software for receiving emails, voicemails, faxes, as well as message notifications as described further herein.

Exemplary embodiments also include a communications device 102E that represents a personal digital assistant (PDA) or similar wireless mobile computer-processing device, as well as a communications device 102F that represents a wireless mobile telephone. Under a subscription agreement with a wireless service provider, communications devices 102E and 102F may communicate over one or more networks (e.g., satellite, radio, cellular), as well as those depicted in the system of FIG. 1.

Also included in the system of FIG. 1 is a distributed network 103 such as a local area network, wide area network, metropolitan area network, etc. For illustrative purposes, the distributed network shown in the system of FIG. 1 is a corporate LAN 103. Corporate LAN 103 represents an enterprise local area network that may include various communications devices (e.g., computer workstations, servers, facsimile machines, telephones, etc., that communicate with one another in a closed network environment such as an Intranet). Corporate LAN 103 communicates with external entities utilizing, e.g., DS1, T1 leased lines, a Virtual Private Network, or similar communications networking means. Servers included in corporate LAN 103 may provide application and file transfer services, database access and storage, and messaging services (e.g., email, facsimile, instant messaging, video conferencing, and voicemail). The messaging service may include unified messaging technologies wherein various types of messaging applications converge to implement and manage disparate types of messages within a single user mailbox.

Communications devices 102A-F and Corporate LAN 103 may receive communications services from one or more service providers. Service providers provide telephone, Internet, and messaging services via multiple network configurations including, e.g., standard PSTN or circuit-switched networks and packet-switched networks that utilize, e.g., Internet Protocol (IP), asynchronous transfer mode (ATM), and frame relay protocols for transmitting digital data.

Service providers may include telephony service providers such as local exchange and interexchange carriers including incumbent and/or competitive exchange carriers. Service providers may further include, or be in communication with, Internet service providers, wireless telephone service providers, Internet telephony service providers, to name a few. By communicating with various types of service provider entities, disparate types of communications and networks can be seamlessly integrated. For example, a voice call initiated from a standard wireline telephone may be processed by a telephone service provider, transmitted to a softswitch where it is converted into digital format, transmitted over an IP network to a second telephone service provider where it is converted to analog format and terminated at a receiving communications device.

Telephone service providers may include central offices 104A-B that receive calls initiated from communications devices 102A-B over PSTN lines. Central offices 104A-B may include automatic number identification (ANI) functionality for performing call number translations. Central offices 104A-B may also include switches for performing call handling and routing functions. One or more transmission channels such as a trunk may be used to carry the calls between central offices 104A-B and switching devices. Central offices 104A-B may also employ trunk gateways 110A-B for receiving analog-formatted calls and converting the analog calls to packetized digital data for transmission over an IP packet network.

A service provider may also utilize a Signaling System 7 (SS7) network to offload congestion on the PSTN network in order to facilitate traffic flow. For example, when central office 104B receives a call from communications device 102B, it sends the call content portion of the signal over a trunk (e.g., a voice circuit) to a trunk gateway 110B as described above, but also sends the call signaling information (e.g., call set up and management data) over an SS7 network 116. SS7 network 116 may include signal transfer points (STPs) that refer to packet switches for routing the traffic through the network. The SS7 network 116 transmits the traffic via reserved channels, or signaling links, that connect the central offices 104A-B, the STPs of network 116, and other network nodes such as a signaling gateway 119 and storage device 118. Each of central offices 104A-B may include a service switching point (SSP) that originates and/or terminates calls and communicates over the SS7 network 116 with a service control point (SCP) database in storage device 118 to determine how to route a call or set up and manage a call feature such as the message delivery and notification features.

Signaling gateway 119, or media gateway, refers to an interface that enables SS7 network 116 and packet-switched networks to communicate. The signaling gateway 119 receives SS7 signals and converts them into packets utilizing, e.g., signaling transport (SIGTRAN) protocol for transmitting the signals over an IP network or softswitch such as softswitch 122. Likewise, signaling gateway 119 receives packetized data from an IP network and converts the data to SS7 signals for transmission over SS7 network 116.

In exemplary embodiments, storage device 118 includes a computer processor such as a server, as well as data storage. Storage device 118 includes a service control point (SCP) database, a messaging database, and the message delivery and notification application. The SCP database communicates with the SS7 network 116 and is queried to determine how calls should be handled (e.g., the SCP is queried for 800-number translation so that the 800-number owner may be billed for the call). The messaging database includes instructions for handling information exchanges among customers, such as email and voicemail exchanges and may store message files, attachments, and emails.

Softswitch 122, or media gateway controller, may include a software-based switching platform application programming interface (API) used for bridging circuit-switched network traffic and packet-switched network traffic, as well as for managing various types of traffic such as voice, fax, data, and video. Softswitch 122 may also accommodate various types of packet-switching technologies for a variety of traffic types (e.g., Voice over Frame Relay (VoFR), Voice over ATM (VoATM), Facsimile over IP (FAXoIP), etc.).

In exemplary embodiments, a host system 124 is included in the system of FIG. 1. Host system 124 may include one or more application servers 126 and storage devices 128 for implementing the message delivery and notification application on behalf of packet-switched network users such as communications devices 102C, 102D, and LAN 103. Data storage device 128 may include a messaging database and the message delivery and notification application as described above with respect to storage device 118.

Host system 124 communicates with softswitch 122 using, e.g., Session Initiated Protocol (SIP), a signaling protocol for Internet telephony. The SIP initiates call setup, routing, authentication, and other feature messages to endpoints within an IP domain.

As indicated above, service providers may implement voicemail services for its customers utilizing, e.g., voicemail servers 132A-B as shown in the system of FIG. 1. Voicemail servers 132A-B may execute a voicemail system application utilizing, for example, an Internet standard such as Voice Profile for Internet Mail (VPIM) that enables the exchange of voicemail and voicemail-based fax messages between mail servers. VPIM wraps encoded voice messages in MIME message parts and uses SMTP to transport them over an IP network. VPIM further enables fax encoding utilizing, e.g., the TIFF-F specification. VPIM enables voicemail servers to handle messages and their constituent parts. Voicemail servers 132A-B may include an LDAP client that enables the message delivery and notification application to receive directory information access services, such as email address look-ups, public keys, and similar types of information. Voicemail servers 132A-B may also include an SMTP host with protocols that enable the message delivery and notification application to send email messages between servers.

In exemplary embodiments, directory services server 136 executes an application for accessing information directories such as a directory database in storage device 138 and facilitates the interoperability of messaging exchanges between the Internet and PSTN networks. Directory services server 136 may utilize open protocols such as LDAP, which enables application servers such as voicemail systems to read and update a corporate white pages directory database, as well as to make requests to a shared public directory to find a recipient's phone number. Directory services server 136 may utilize the addressing formats of the International Telecommunication Union (E.164) or the North American Numbering Plan (NANP: 123-555-1212), along with internal corporation-specific numbering plans that may include a site number and voice mailbox number or extension (e.g., 62-1433). Directory services server 136 may implement open messaging functions by applying Internet-routable addresses based upon a given telephone number. Shared directories may be utilized to achieve this feature (e.g., corporate white pages, shared public or inter-enterprise directories, etc.).

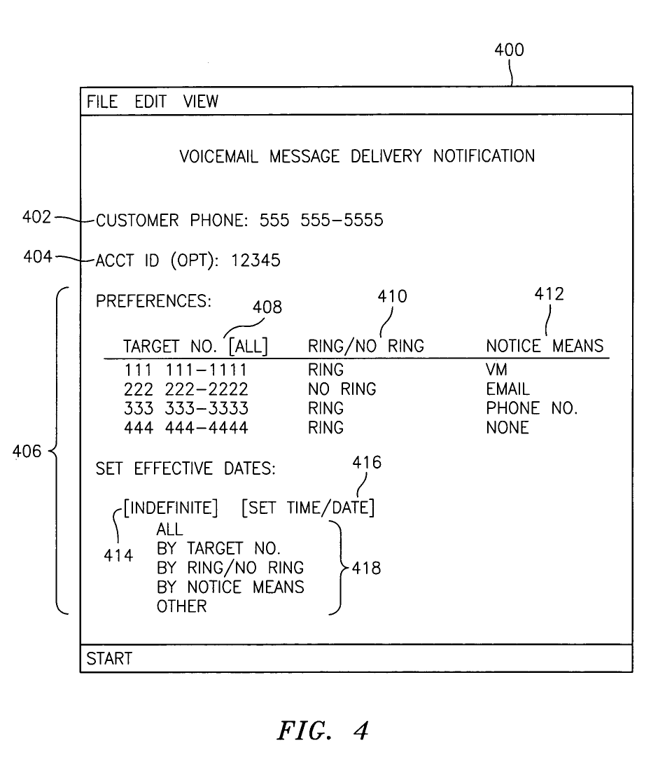

Profile server 140 enables customers of a service provider to manage their message delivery and notification accounts (e.g., setting preferences, adding or deleting services relating to the message delivery and notification account, etc.). Profile server 140 may include a default directory that establishes and maintains default settings for customers who do not wish to customize their own individual preferences. The features provided by the profile server 140 are described further herein with respect to FIG. 4. Media server 142 provides sound, pictures, and video content services to customers

In exemplary embodiments, a multiprotocol label switching (MPLS) network 114 is also included in the system of FIG. 1. MPLS network 114 may employ routers in a manner that eliminates the need for multiple layers that exist in most carrier networks (e.g., SONET/SDH deployed at layer 1, ATM at layer 2, and IP at layer 3). In the MPLS network 114, incoming packets are assigned a label by a label edge router (LER). Packets are forwarded along a label switch path (LSP), where each label switch router (LSR) makes a decision on how to forward the packets based upon the label contents. At each hop, the LSR removes the existing label and applies a new label, which then provides instructions to the next hop regarding the forwarding of the packet. A label switch path may be established by a network operator for enhancing system performance, routing traffic around network congestion, or creating IP tunnels for network-based virtual private network. MPLS network 114 may utilize several standards adopted by the Internet Engineering Task Force (IETF) organization. MPLS network 114 works with the Internet Protocol, Asynchronous Transport Mode (ATM), and frame relay network protocols, among others. MPLS network 114 receives signals from network entities such as servers 132A-B, 140, 136, and 142, as well as from trunk gateways 110A-B, softswitch 122, corporate LAN 103, and communications devices 102D-F.

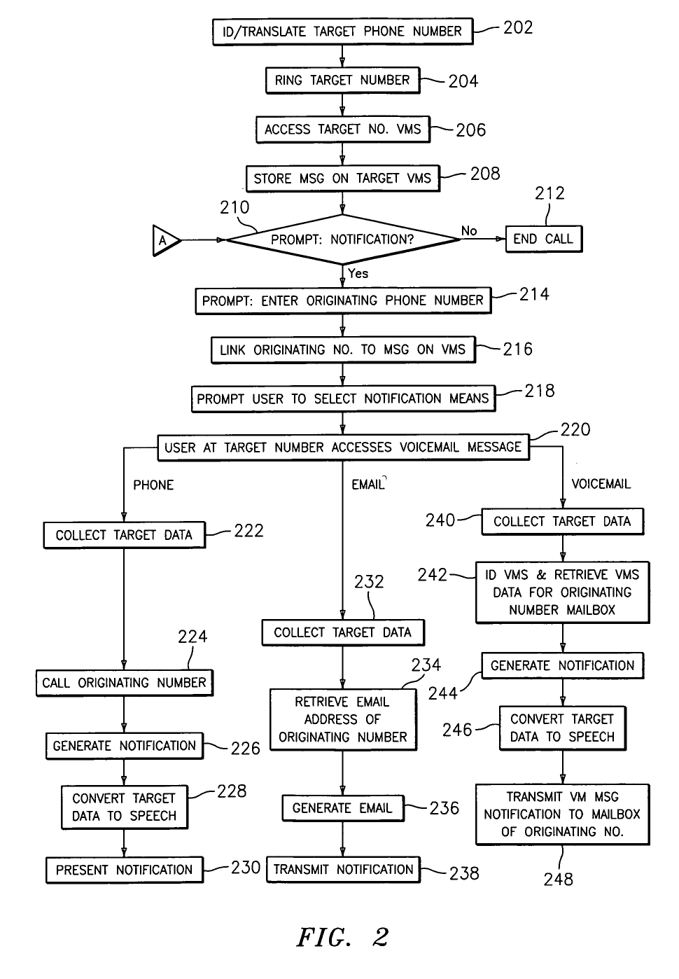

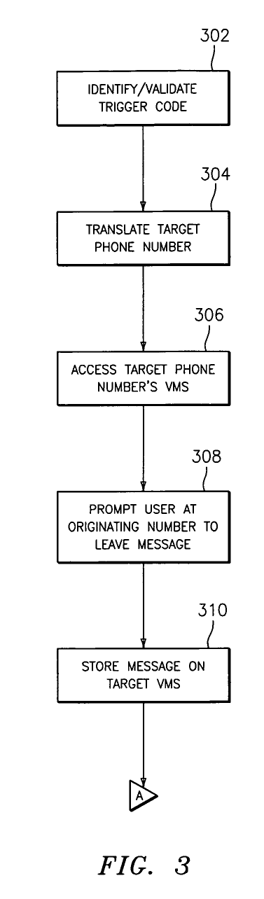

Turning now to FIG. 2, an exemplary process for implementing the message delivery and notification services will now be described. For ease of explanation, the processes described with reference to FIGS. 2 and 3 assume that an individual (calling party) from communications device 102A has initiated a call to a second individual (target party) on communications device 102B. The message delivery and notification services offer two options for the calling party. The first option allows the calling party to ring the target party's communications device, leave a message when there is no answer, and receive notification when the target party retrieves the message. The second option enables the calling party to leave a voicemail message on the target party device's voicemail without first ringing the target device and receive notification when the target party retrieves the message. The first option is described with respect to FIG. 2, and the second option is described with respect to both FIGS. 2 and 3.

At 202, the called number, or target number is identified and translated at central office 104A. The call is transmitted to the target communications device 102B causing the device 102B to ring at 204. The message delivery and notification application determines that the call has not been answered by the target party and accesses the target party's voice mailbox on voicemail server 132B at 206. A voice message is entered by the calling party and stored in the voice mailbox of the target party at 208. The voicemail message at target voicemail server 132B may contain a record for the target party that includes a name, phone number, voice mailbox number/ID, the content of new and saved messages, and the timestamps relating to these messages.

At 210, the message delivery and notification application queries the calling party to determine whether the caller would like to be notified when the target party accesses the voicemail at 212. The prompt may include instructions such as “If you would like to be notified when this message is retrieved by the recipient, please says ‘yes’ or press “1” now. Otherwise, you may hang up.” If the calling party relates that he/she does not wish to be notified, the call ends at 212. Otherwise, the caller is prompted to enter his/her phone number at 214. Alternatively, the message delivery and notification application may utilize an automated number identification (ANI) system via central office 104B and the SCP database of storage device 118 that identifies the calling party's telephone number without input from the calling party.

The phone number entered by the calling party at 214 is linked to the voicemail message left in the target party's voice mailbox at 216. The user is then prompted to select a notification means at 218. Available notification options may include telephone (voice) notification, email or instant messaging notification, and voicemail notification. In alternative embodiments, notification may be by facsimile or other similar means.

The calling party ends the call and waits for the notification. The target party accesses the voicemail on voicemail server 132B at 220. If the calling party selected a telephone notification, the process continues as described at 222-230. The message delivery and notification application collects data about the target party and message retrieval at 222. For example, the date and timestamp issued by the voicemail server at the time the message is retrieved may be collected. Also, the name of the target party may be used in the notification. At 224, the message delivery and notification application calls the number that was provided by the calling party at 214. The message delivery and notification application generates a notification by accessing a canned voice message. The message delivery and notification application then converts the collected target data to speech format at 228, and presents the notification in speech form to the calling party at 230.

Returning to 220, if the calling party selected to be notified by email, the process continues at 232 and proceeds through 238. In this event, it is assume for illustrative purposes that the caller on communications device 102A has an email account. The message delivery and notification application collects data about the target party and message retrieval at 232 as described above at 222. The message delivery and notification application retrieves the email address of the calling party at 234. This may be accomplished by accessing the directory services server 136 and searching the directory database of storage device 138 using the calling party's phone number as a key. A predetermined email notification is generated by the message delivery and notification application at 236. The notification may include the calling party's name, target party's name, and the date/time that the target party retrieved the message. Utilizing the functionality of the multi-protocol label switching network 114, the email notification is transmitted to the calling party's email address at 238.

If the calling party selected a voicemail message notification at 220, the process continues at 240 and proceeds through 248. The message delivery and notification application collects data about the target party and message retrieval at 240 as described above at 222 and 232. The message delivery and notification application identifies the voicemail system server of the party to be notified (e.g., voicemail server 142) and retrieves the voicemail system data (mailbox information) at 242. The message delivery and notification application generates a notification message by accessing a canned voice message at 244, converts the collected data to speech format at 246, calls the voicemail number for the calling party and presents the combined notification in speech form to the calling party's voice mailbox at 248.

For Internet-enabled communications devices such as communications devices 102C and 102D, the processes described above may be facilitated by the message delivery and notification application executing on server 126.

As indicated above, the calling party also has the option of leaving a voicemail message with the target party without ringing the target communications device. An exemplary process for implementing this feature of the message delivery and notification application will now be described with respect to FIG. 3. A calling party (e.g., communications device 102C) enters a unique code (also referred to herein as a trigger code) into the communications device at 302. The trigger code may be a defined set of inputs to the communication device such as *12. This trigger code is entered before entering the target telephone number in order to preempt the service provider system from ringing the number entered. After the trigger code is entered, the calling party enters the target phone number at 304. The host system 124 is accessed via softswitch 122 which, in turn, identifies and validates the trigger code entered at 302, followed by translating the target number entered at 304. The message delivery and notification application accesses the target phone number's voicemail system (e.g., 132A) at 306 without ringing the target party's telephone. At 308, the calling party is prompted to leave a message on the target voicemail system. The message is stored on the target voicemail system at 310 and the process resumes at 210 with respect to FIG. 2 for implementing the notification options as described above.

Exemplary embodiments of the invention include establishing a profile with user preferences by a calling party for implementation of the message delivery and notification services. A calling party may select preferences for handling messages left on target devices, as well as preferences for handling notification of message retrieval. This may be accomplished, e.g., by accessing a web site for the message delivery and notification service provider and entering the appropriate selections. A sample user interface screen and user account information are shown and described in FIG. 4.

The user interface screen 400 as shown in FIG. 4 displays the phone number of the account holder 402, an account identification code 404 (optional), and various preference settings 406. The account identification code 404 may be utilized in situations whereby multiple individuals associated with a single phone number would like to establish their own individual settings. A unique account identification code may be generated for each individual in order to distinguish between these individuals.

The user may establish preferences based upon the target phone number, the ring/no ring function, and notification means. As shown in FIG. 4, a target number column 408 enables the user to specify individual target phone numbers to apply a function. The user may alternatively apply the function to all target numbers called by the user without specifying the numbers individually. Column 410 further enables a user to specify whether to ring a target number prior to leaving a voicemail message. The user may also specify which means of notification should be applied based upon the target number called as shown generally in column 412.

Another preference setting includes specifying a duration for which the function should be applied. The user may select ‘indefinite’ 414 or may indicate a specific date/time 416 as desired. These effective dates may be further classified by criteria 418 such as all, by target number, by ring/no ring function, by notification means, etc. At any time, the user may access their profile and modify these settings if desired.

While not specifically shown in FIG. 4, the message delivery and notification application may access a user profile that has been established for other communications services and which relate to or impact the services provided by the message delivery and notification application. For example, the message delivery and notification application may access information in a user profile in which the user has specified his/her availability and/or also which device he/she may wish others use to establish communicate with the user. These preferences may include availability by time of day, day of week, etc. such that the message delivery and notification application contacts the profile server 140 to determine the calling party availability at a particular point in time and for to direct the transmission of the notification.

The message delivery and notification services enable a calling individual to leave voicemail messages with a target party and receive instant notification when the target party accesses the message. The message and delivery notification services further enable a calling party to bypass a portion of the initiated call by leaving a voicemail without first establishing voice contact with a party. The message delivery and notification services accommodate multiple types and formats of notifications to include telephone messages, voicemail messages, email, and facsimile, to name a few.

As described above, the present invention can be embodied in the form of computer-implemented processes and apparatuses for practicing those processes. The present invention can also be embodied in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

What is claimed is:

1. A method for providing message delivery and notification services, comprising:
collecting data associated with a message;
collecting notification information relating to an originator of the message;
generating a notification in response to the notification information, the generating performed when the message is accessed by a recipient; and
transmitting the notification to the originator of the message.

2. The method of claim 1, wherein said message is a voicemail.

3. The method of claim 1, further comprising:
upon receiving a request, conveying the message to a message inbox of the recipient without establishing direct contact with the recipient.

4. The method of claim 1, wherein the collecting data associated with a message includes:
identifying at least one of a name and telephone number of the recipient;
collecting content of the message; and
collecting a timestamp and datestamp associated with the message.

5. The method of claim 1, wherein the collecting notification information relating to an originator of the message includes collecting a notification means and at least one of:
a name;
a telephone number;
an email address;
a voicemail server and corresponding voice mailbox number; and
a facsimile number.

6. The method of claim 1, wherein the generating a notification in response to the notification information includes:
converting the notification information and the data associated with a message into a format specified in accordance with a request for the notification; and
combining the notification information and the data associated with a message into a predetermined message.

7. The method of claim 1, wherein the transmitting the notification to the originator of the message includes transmitting the notification to at least one of:
a telephone;
an email mailbox;
a facsimile machine; and
a voicemail box.

8. The method of claim 5, wherein the notification means is selected by the originator of the message.

9. The method of claim 1, wherein the transmitting the notification includes transmitting the notification via at least one of:
a circuit-switched network; and
a packet-switched network.

10. The method of claim 1, wherein the originator of the message communicates the message via at least one of:
a wireline telephone;
a computer;
a wireless telephone; and
a mobile computing device.

11. A system for providing message delivery and notification services, comprising:
a host system in communication with a calling device over a network, the host system executing a message delivery and notification application for collecting data associated with a message, collecting notification information relating to an originator of the message, generating a notification in response to the notification information, the generating performed when the message is accessed by a recipient, and transmitting the notification to the originator of the message.

12. The system of claim 11, wherein the message delivery and notification application further performs:
upon receiving a request, conveying the message to a message inbox of the recipient without establishing direct contact with the recipient.

13. The system of claim 11, wherein the collecting data associated with a message includes:
identifying at least one of a name and telephone number of the recipient;
collecting content of the message; and
collecting a timestamp and datestamp associated with the message.

14. The system of claim 11, wherein the collecting notification information relating to an originator of the message includes collecting a notification means and at least one of:
a name;
a telephone number;
an email address;
a voicemail server and corresponding voice mailbox number; and
a facsimile number.

15. The system of claim 11, wherein the generating a notification in response to the notification information includes:
converting the notification information and the data associated with a message into a format specified in accordance with a request for the notification; and
combining the notification information and the data associated with a message into a predetermined message.

16. The system of claim 11, wherein the transmitting the notification to the originator of the message includes transmitting the notification to at least one of:
a telephone;
an email mailbox;
a facsimile machine; and
a voicemail box.

17. The system of claim 14, wherein the notification means is selected by the originator of the message.

18. The system of claim 12, wherein the transmitting the notification includes transmitting the notification via at least one of:
a circuit-switched network; and
a packet-switched network.

19. The system of claim 11, wherein the originator of the message communicates the message via at least one of:
a wireline telephone;
a computer;
a wireless telephone; and
a wireless mobile computing device.

20. A storage medium encoded with machine-readable computer program code for providing message delivery and notification services, the program code including instructions for causing a host system to implement a method, comprising:
collecting data associated with a message;
collecting notification information relating to an originator of the message;
generating a notification in response to the notification information, the generating performed when the message is accessed by a recipient; and
transmitting the notification to the originator of the message.
